(19) United States
(12) Patent Application Publication
(10) Pub. No.: US 2026/0179042 A1
(43) Pub. Date: Jun. 25, 2026

(54) GENERATION OF PRODUCT DOCUMENTATION USING ARTIFICIAL INTELLIGENCE MODELS

(71) Applicant: International Business Machines Corporation, Armonk, NY (US)

(72) Inventors: Renjith Ramakrishnan, Kollam (IN); SUMAN PATRA, RARITAN, NJ (US); PIYUSH RUDRAPRATAP MISHRA, Boonton, NJ (US); Pramod Nanjundaiah, Bangalore (IN)

(21) Appl. No.: 18/989,668

(22) Filed: Dec. 20, 2024

(51) Int. Cl. G06Q 10/10

(52) U.S. Cl. CPC G06Q 10/10

(57) ABSTRACT

Generation of product documentation using artificial intelligence models includes receiving a template comprising a set of preferences of a set of stakeholders associated with a product, a product story associated with the product, and a source code associated with the product. A generative artificial intelligence (AI) model is applied to the template, the product story, and the source code. Based on the set of preferences of the set of stakeholders and the application of the generative first AI model to the template, the product story, and the source code, a product documentation associated with the product is generated. The generated product documentation is rendered.

### BACKGROUND

The disclosure relates to the generation of product documentation and more particularly, to the generation of product documentation using artificial intelligence models.

In today's fast-paced and competitive market, efficient and comprehensive product documentation is vital for the successful deployment, operation, and maintenance of various products, including software applications, hardware devices, and complex systems. Product documentation encompasses a wide range of materials, such as user manuals, technical guides, release notes, and compliance certifications, which are crucial for ensuring proper usage, troubleshooting, and regulatory compliance. Traditionally, generating these documents has been a manual, cumbersome, and time-consuming process that often requires the collaboration of multiple teams, including product development, technical writing, and quality assurance.

Even though product documentation is crucial, the manual creation process is prone to several challenges, including inconsistencies in content, delays in documentation availability, a lack of standardization across different product versions, and human errors. As products evolve rapidly with frequent updates and new feature releases, maintaining up-to-date and accurate documentation becomes even more challenging. These issues can lead to customer dissatisfaction, increased support costs, and potential compliance risks.

### SUMMARY

According to an embodiment of the disclosure, a computer-implemented method for the generation of product documentation using artificial intelligence models is described. The computer-implemented method includes receiving, by a computer, a template including a set of preferences of a set of stakeholders associated with a product, a product story associated with the product, and a source code associated with the product. The product story includes at least one of a set of enhancements in the product or a set of features of the product. The computer-implemented method further includes applying, by the computer, a first generative artificial intelligence (AI) model to the template, the product story, and the source code. The computer-implemented method further includes generating, by the computer, a first product documentation associated with the product based on the set of preferences of the set of stakeholders and the application of the first generative AI model to the template, the product story, and the source code. The computer-implemented method further includes rendering, by the computer, the generated first product documentation.

According to one or more embodiments of the disclosure, a computer system for the generation of product documentation using artificial intelligence models is described. The computer system performs a method for the generation of product documentation using artificial intelligence models. The method includes receiving a template including a set of preferences of a set of stakeholders associated with a product, a product story associated with the product, and a source code associated with the product. The product story includes at least one of a set of enhancements in the product or a set of features of the product The method further includes applying a generative artificial intelligence (AI) model to the template, the product story, and the source code. The method further includes generating a first product documentation associated with the product based on the application of the generative AI model to the template, the product story, and the source code. The first product documentation is generated in accordance with the set of preferences of the set of stakeholders. The method further includes rendering the generated first product documentation.

According to one or more embodiments of the disclosure, a computer program product for the generation of a generation of a product documentation using a generative artificial intelligence (AI) model is described. The computer program product includes one or more computer-readable storage media. The program instructions are stored on the one or more computer-readable storage media to perform operations. The operations include receiving a template that comprises a set of preferences of a set of stakeholders associated with a product, a product story associated with the product, and a source code associated with the product. The product story includes at least one of a set of enhancements in the product or a set of features of the product. The operations further include applying the generative AI model to the template, the product story, and the source code. The operations further include generating the product documentation associated with the product based on the set of preferences of the set of stakeholders and the application of the generative AI model to the template, the product story, and the source code. The operations further include rendering the generated product documentation.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for the generation of product documentation using artificial intelligence models, in accordance with an embodiment of the disclosure;

FIG. 2 is a diagram that illustrates an environment for the generation of product documentation using artificial intelligence models, in accordance with an embodiment of the disclosure;

FIG. 3A and FIG. 3B, collectively, is a diagram that illustrates exemplary operations for the generation of product documentation using artificial intelligence models, in accordance with an embodiment of the disclosure;

FIG. 4 is a diagram that illustrates exemplary operations for modification of product documentation, in accordance with an embodiment of the disclosure;

FIG. 5A is a diagram that illustrates an exemplary first user interface for the generation of product documentation using artificial intelligence models, in accordance with an embodiment of the disclosure;

FIG. 5B is a diagram that illustrates an exemplary second user interface for the generation of product documentation using the artificial intelligence models, in accordance with an embodiment of the disclosure; and

FIG. 6 is a flowchart that illustrates an exemplary method for the generation of product documentation using artificial intelligence models, in accordance with an embodiment of the disclosure.

### DETAILED DESCRIPTION

Nowadays, effective product documentation is crucial to the success of any product (say software), as it enables faster product adoption, enhances user experience, and provides clarity on product capabilities. Generally, product documentation must address the needs of diverse audiences, including business users who need to understand what product capabilities are available and how they align with business goals, application developers who require detailed guidance on how to get started with the product using code samples and integration points, and technical sales professionals who focus on why the product is relevant to the industry by highlighting competitive advantages and use cases.

Currently, the creation of product documentation is a manual and labor-intensive process. It is typically managed by technical writers who must work in close collaboration with the product development team to capture and document the latest features, changes, and usage instructions. This manual approach requires a significant investment of time and resources, and it also imposes a tight dependency on the development cycle. Every product update or new release requires corresponding updates to the documentation to ensure it accurately reflects the latest features, bug fixes, and enhancements. This continuous need for updates makes maintaining up-to-date documentation a challenging and resource-intensive task.

Moreover, online documentation resources such as FAQs, tutorials, readmes, and other instructional content are usually tied to specific software or application versions. As a result, each version's documentation must be updated or recreated to remain relevant and useful to end-users. Failure to maintain accurate and current documentation leads to user confusion, increased support requests, and a slower rate of product adoption. Given these challenges, there is a need for a more efficient and automated solution that can streamline the generation and maintenance of product documentation.

The proposed disclosure aims to address these challenges by providing a computer system and method for the automatic generation of product documentation. This disclosed computer system integrates seamlessly with the product development lifecycle, leveraging advancements in natural language processing, data extraction, and template-based content creation to automatically gather relevant information from various sources such as source code repositories, project management tools, and configuration files. The disclosed system utilizes this information to generate comprehensive, standardized, and up-to-date documentation with minimal human intervention using artificial intelligence (AI) models.

By automating the documentation process, the disclosed computer system may significantly enhance efficiency and productivity, reducing the time and effort required to create and update product documentation. Such automation may ensure consistency and accuracy across different product versions and releases, thereby minimizing errors and discrepancies that often occur in manual documentation processes. Furthermore, such automation may also allow product teams to synchronize documentation updates with product releases, ensuring that the product documentation is available as soon as a new version is launched. This not only accelerates the product's time-to-market but also supports faster user adoption.

Moreover, automating the generation of product documentation can significantly reduce costs associated with the manual documentation process, including the need for extensive technical writing resources and the risk of outdated or incorrect documentation. Furthermore, by providing accurate, up-to-date, and comprehensive product documentation that caters to the specific needs of different user groups, the disclosed computer system enhances the overall user experience, reduces support queries, and increases customer satisfaction. The disclosed computer system can easily scale to support multiple products and versions, making it an ideal solution for organizations with a large portfolio of software products or frequently updated applications.

Therefore, the disclosure aims to transform the product documentation generation process by automating the generation and maintenance of high-quality documentation. By leveraging advanced technologies such as artificial intelligence (AI) models (specifically language models), the disclosure addresses the shortcomings of the traditional manual approach, offering a more efficient, cost-effective, and scalable solution that ensures documentation remains aligned with the evolving needs of diverse user groups throughout the product lifecycle.

According to an embodiment of the disclosure, a computer-implemented method for the generation of product documentation using artificial intelligence models is described. The computer-implemented method includes receiving, by a computer, a template including a set of preferences of a set of stakeholders associated with a product, a product story associated with the product, and a source code associated with the product. The product story includes at least one of a set of enhancements in the product or a set of features of the product. The computer-implemented method further includes applying, by the computer, a first generative artificial intelligence (AI) model to the template, the product story, and the source code. The computer-implemented method further includes generating, by the computer, a first product documentation associated with the product based on the set of preferences of the set of stakeholders and the application of the first generative AI model to the template, the product story, and the source code. The computer-implemented method further includes rendering, by the computer, the generated first product documentation.

In an embodiment of the disclosure, the computer-implemented method further includes applying, by the computer, a second generative AI model to the product story. The computer-implemented method further includes generating, by the computer, each of a first summary and a second summary based on the application of the second generative AI model to the product story. The first summary is associated with the set of enhancements in the product and the second summary is associated with the set of features in the product. The computer-implemented method further includes applying, by the computer, the first generative AI model to the first summary and the second summary. The computer-implemented method further includes generating, by the computer, the first product documentation based on the application of the first generative AI model to the first summary, and the second summary.

In an embodiment of the disclosure, the computer-implemented method further includes applying, by the computer, a third generative AI model to the source code. The computer-implemented method further extracting, by the computer, a set of technical specifications associated with the product based on the application of the third generative AI model to the source code. The computer-implemented method further includes associating, by the computer, the set of technical specifications with at least one of the set of enhancements in the product or the set of features of the product. The computer-implemented method further includes applying the first generative AI model to the association of the set of technical specifications with at least one of the set of enhancements in the product or the set of features of the product. The computer-implemented method further includes generating, by the computer, the first product documentation based on an application of the first generative AI model to the association of the set of technical specifications with at least one of the set of enhancements in the product or the set of features of the product.

In an embodiment of the disclosure, the computer-implemented method further includes receiving, by the computer, a first set of exemplary codes. The computer-implemented method further includes applying, by the computer, a fourth generative AI model to the first set of exemplary codes. The computer-implemented method further includes generating, by the computer, a second set of exemplary codes based on the association and the application of the fourth generative AI model to the first set of exemplary codes. The computer-implemented method further includes applying, by the computer, the first generative AI model to the second set of exemplary codes. The computer-implemented method further includes generating, by the computer, the first product documentation based on the application of the first generative AI model to the second set of exemplary codes.

In an embodiment of the disclosure, the computer-implemented method further includes receiving, by the computer, a second product documentation associated with the product. The second product documentation is associated with a prior version of the product. The computer-implemented method further includes merging, by the computer, the first product documentation with the second product documentation. The computer-implemented method further includes modifying, by the computer, the first product documentation based on the merging of the first product documentation with the second product documentation. The computer-implemented method further includes rendering, by the computer, the modified first product documentation.

In an embodiment of the disclosure, the computer-implemented method further includes applying, by the computer, a fifth generative AI model to the modified first product documentation. The computer-implemented method further includes generating, by the computer, a set of release notes associated with the product based on the application of the fifth generative AI model to the modified first product documentation. The computer-implemented method further includes rendering, by the computer, the generated set of release notes.

In an embodiment of the disclosure, the computer-implemented method further includes comparing, by the computer, the first product documentation with the second product documentation. The computer-implemented method further includes tagging, by the computer, each update of a set of updates in the first product documentation based on the comparison. The computer-implemented method further includes transmitting, by the computer, the first product documentation to a user device. Each update of the set of updates is tagged in the first product documentation.

In an embodiment of the disclosure, the computer-implemented method further includes receiving, by the computer, a first input from the user device. The first input corresponds to an approval of the set of updates. The computer-implemented method further includes rendering, by the computer, the generated first product documentation based on the received first input.

In an embodiment of the disclosure, the computer-implemented method further includes receiving, by the computer, a second input from the user device. The second input corresponds to a disapproval of at least one update of the set of updates. The computer-implemented method further includes modifying, by the computer, the generated first product documentation based on the received second input. The computer-implemented method further includes rendering, by the computer, the modified first product documentation.

In an embodiment of the disclosure, the computer-implemented method further includes receiving, by the computer, a third input from the user device. The third input includes a query associated with at least one update of the set of updates. The computer-implemented method further includes determining, by the computer, update information associated with the at least one update in the first product documentation based on the received third input. The computer-implemented method further includes determining, by the computer, one or more reasons for the at least one update based on the determined update information. The computer-implemented method further includes rendering, by the computer, the determined one or more reasons.

In an embodiment of the disclosure, the set of stakeholders corresponds to one of business users, end users, product developers, sales representatives, system administrators, or marketing representatives.

According to one or more embodiments of the disclosure, a computer system for the generation of product documentation using artificial intelligence models is described. The computer system includes a processor set, one or more computer-readable storage media, and program instructions stored on the one or more computer-readable storage media. The program instructions executable by the processor set to cause the processor set to receive a template that includes a set of preferences of a set of stakeholders associated with a product, a product story associated with the product, and a source code associated with the product. The product story includes at least one of a set of enhancements in the product or a set of features of the product. The program instructions cause the processor set to apply a generative artificial intelligence (AI) model to the template, the product story, and the source code. The program instructions cause the processor set to generate a first product documentation associated with the product based on the set of preferences of the set of stakeholders and the application of the generative AI model to the template, the product story, and the source code. The program instructions cause the processor set to render the generated first product documentation.

In an embodiment of the disclosure, the program instructions cause the processor set to apply the generative AI model to the source code. The program instructions cause the processor set to extract a set of technical specifications associated with the product based on the application of the generative AI model to the source code. The program instructions cause the processor set to associate the set of technical specifications with the at least one of the set of enhancements in the product or the set of features of the product. The program instructions cause the processor set to apply the generative AI model to the association of the set of technical specifications with the at least one of the set of enhancements in the product or the set of features of the product. The program instructions cause the processor set to generate the first product documentation based on the application of the generative AI model to the association of the set of technical specifications with the at least one of the set of enhancements in the product or the set of features of the product.

In an embodiment of the disclosure, the program instructions cause the processor set to receive a first set of exemplary codes. The program instructions cause the processor set to apply the generative AI model to the first set of exemplary codes. The program instructions cause the processor set to generate a second set of exemplary codes based on the association and the application of the generative AI model to the first set of exemplary codes. The program instructions cause the processor set to apply the generative AI model to the second set of exemplary codes. The program instructions cause the processor set to generate the first product documentation based on the application of the generative AI model to the second set of exemplary codes.

In an embodiment of the disclosure, the program instructions cause the processor set to receive a second product documentation associated with the product. The second product documentation is associated with a prior version of the product. The program instructions cause the processor set to merge the first product documentation with the second product documentation. The program instructions cause the processor set to modify the first product documentation based on the merger of the first product documentation with the second product documentation. The program instructions cause the processor set to render the modified first product documentation.

In an embodiment of the disclosure, the program instructions cause the processor set to apply the generative AI model to the modified first product documentation. The program instructions cause the processor set to generate a set of release notes associated with the product based on the application of the generative AI model to the modified first product documentation. The program instructions cause the processor set to render the generated set of release notes.

In an embodiment of the disclosure, the program instructions cause the processor set to compare the first product documentation with the second product documentation. The program instructions cause the processor set to tag each update of a set of updates in the first product documentation based on the comparison. The program instructions cause the processor set to transmit the first product documentation to a user device based on the tagging of each update of the set of updates in the first product documentation.

In an embodiment of the disclosure, the set of stakeholders corresponds to one of business users, end users, product developers, sales representatives, system administrators, or marketing representatives.

According to one or more embodiments of the disclosure, a computer program product for the generation of a generation of a product documentation using a generative artificial intelligence (AI) model is described. The computer program product includes one or more computer-readable storage media. The program instructions are stored on the one or more computer-readable storage media to perform operations. The operations include receiving a template that comprises a set of preferences of a set of stakeholders associated with a product, a product story associated with the product, and a source code associated with the product. The product story includes at least one of a set of enhancements in the product or a set of features of the product. The operations further include applying the generative AI model to the template, the product story, and the source code. The operations further include generating the product documentation associated with the product based on the set of preferences of the set of stakeholders and the application of the generative AI model to the template, the product story, and the source code. The operations further include rendering the generated product documentation.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

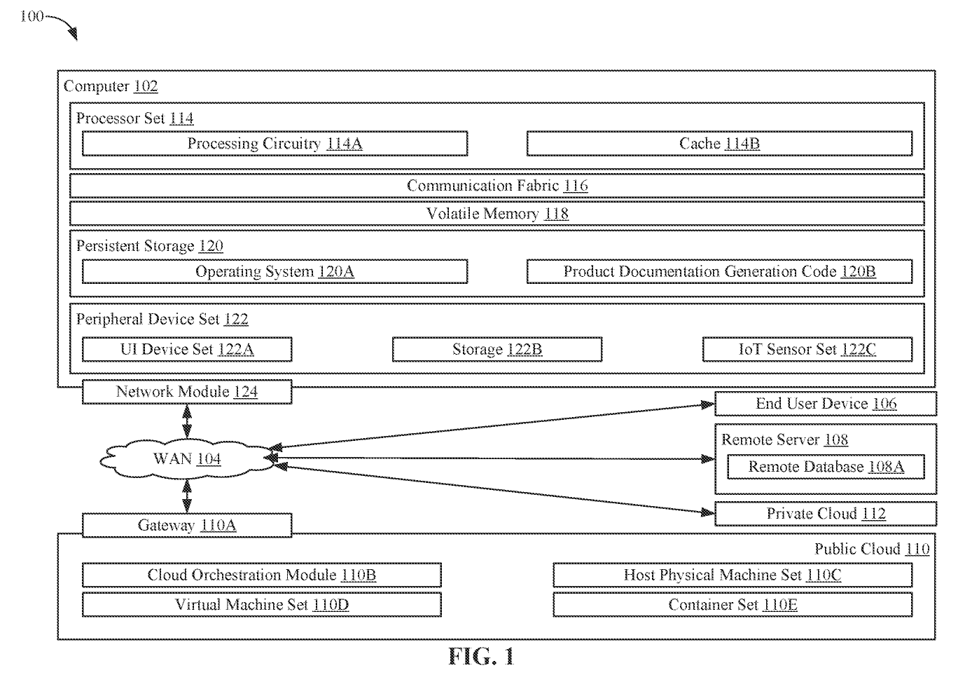

FIG. 1 is a diagram that illustrates a computing environment for the generation of product documentation using artificial intelligence models, in accordance with an embodiment of the disclosure. With reference to FIG. 1, there is shown a computing environment 100 that contains an example of an environment for the execution of at least some of the computer code involved in performing the disclosed methods, such as a product documentation generation code 120B. In addition to the product documentation generation code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the product documentation generation code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 130. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the other storage media discussed below. The program instructions, and associated data, are accessed by the processor set 114 to control and direct the performance of the disclosed methods. In computing environment 100, at least some of the instructions for performing the disclosed methods may be stored in the dynamic modification of the product documentation generation code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the product documentation generation code 120B typically includes at least some of the computer code involved in performing the disclosed methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In an embodiment of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 130 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in some embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

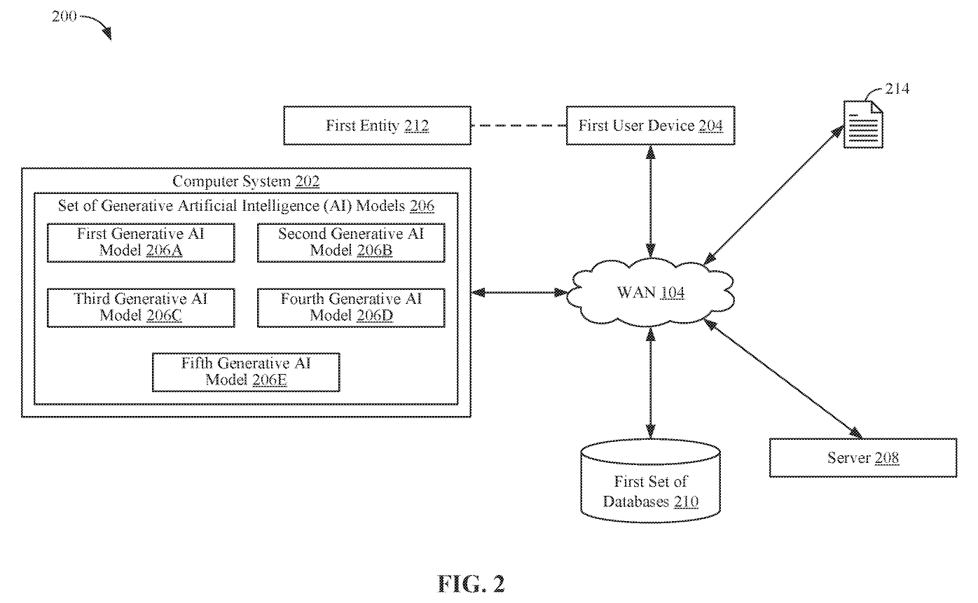

FIG. 2 is a diagram that illustrates an environment for the generation of product documentation using artificial intelligence models, in accordance with an embodiment of the disclosure. FIG. 2 is explained in conjunction with elements from FIG. 1. With reference to FIG. 2, there is shown a diagram of a network environment 200. The network environment 200 includes a computer system 202 (hereinafter also referred to as “system”), a first user device 204, a set of generative artificial intelligence (AI) models 206, and a server 208. There is further shown a first set of databases 210. The network environment 200 further includes a first entity 212 associated with the first user device 204, and a first product documentation 214 associated with a product. The network environment 200 further includes the WAN 104 of FIG. 1. The set of generative AI models 206 may include a first generative AI model 206A, a second generative AI model 206B, a third generative AI model 206C, a fourth generative AI model 206D, and a fifth generative AI model 206E. In an embodiment of the disclosure, the first user device 204 may be an exemplary embodiment of the EUD 106. Similarly, the system 202 may be an exemplary embodiment of the computer 102 in FIG. 1.

The system 202 may include suitable logic circuitry, interfaces, and/or code that are configured for the generation of the first product documentation 214 using the set of generative AI models 206. The system 202 is configured to receive a template that includes a set of preferences of a set of stakeholders associated with the product, a product story associated with the product, and a source code associated with the product. The product story includes at least one of a set of enhancements in the product or a set of features of the product. The system 202 is further configured to apply the first generative AI model 206A to the template, the product story, and the source code. The system 202 is further configured to generate the first product documentation 214 associated with the product based on the set of preferences of the set of stakeholders and the application of the first generative AI model 206A to the template, the product story, and the source code. The system 202 is further configured to render the generated first product documentation 214. Examples of the system 202 may include, but are not limited to, a server, a computing device, a virtual computing device, a mainframe machine, a computer workstation, a smartphone, a cellular phone, a mobile phone, a gaming device, or a consumer electronic (CE) device.

The first user device 204 may include suitable logic, circuitry, interfaces, and/or code that are configured to transmit the template, the product story, the source code, or any combination thereof. The first user device 204 is further configured to transmit the received template, the received product story, the received source code, or any combination thereof to the system 202. In an embodiment, the first user device 204 may include a display screen. In an embodiment of the disclosure, the first user device 204 is further configured to render the generated first product documentation 214 on the display screen associated with the first user device 204. The first user device 204 may be associated with the first entity 212. In an embodiment of the disclosure, the first entity 212 may correspond to a stand-alone user, a stakeholder of the set of stakeholders associated with the product, or an organization. The set of stakeholders corresponds to one of, but is not limited to, business users, end users, product developers, sales representatives, system administrators, or marketing representatives. Examples of the first user device 204 may include, but are not limited to, a computing device, a mainframe machine, a server, a computer work-station, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any other device with computer vision display capabilities.

The display screen may include suitable logic, circuitry, and interfaces that are configured to render the generated first product documentation 214. In some embodiments of the disclosure, the display screen may be an external display device associated with the first user device 204. The display screen may be a touch screen which may enable the first entity 212 to provide the template, the product story, the source code, or any combination thereof via the display screen. The touch screen may be at least one of a resistive touch screen, a capacitive touch screen, or a thermal touch screen. In accordance with an embodiment of the disclosure, the display screen may refer to a display screen of a head-mounted device (HMD), a smart-glass device, a see-through display, a projection-based display, an electro-chromic display, or a transparent display. In some embodiments of the disclosure, the display screen may be realized through several known technologies such as, but are not limited to, at least one of a Liquid Crystal Display (LCD) display, a Light Emitting Diode (LED) display, a plasma display, or an Organic LED (OLED) display technology, or other display devices.

Each generative AI model of the set of generative AI models 206 may correspond to a computer-based system or software that exhibits characteristics commonly associated with human intelligence. Each generative AI model of the set of generative AI models 206 may be designed to perform tasks that typically require human intelligence, such as problem-solving, learning, reasoning, perception, understanding natural language, and decision-making. AI systems can range from simple rule-based programs to sophisticated, self-learning systems.

Each generative AI model of the set of generative AI models 206 may be a sophisticated piece of software that leverages natural language processing (NLP) and machine learning techniques to understand, generate, and manipulate human language. For example, each generative AI model of the set of generative AI models 206 may correspond to a language model or a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. For example, the LLM model for language processing may be implemented using GPT, Bidirectional Encoder Representations from Transformers (BERT), and the like.

Further, the LLM may be a type of ML model specifically designed to understand, generate, and manipulate human language on a large scale. LLMs may leverage machine learning techniques, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

For example, the LLMs may be considered to be built on Transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. For example, the LLMs may generate contextual representations of words, meaning that the representation of a word is influenced by its surrounding context. This enables the model to capture the meaning of words in different contexts.

Recently, the use of LLMs has increased manifold for a variety of language-related tasks, such as sentiment analysis, text classification, question answering, machine translation, summarization, and conversational agents. Due to a large number of parameters, training of LLMs from scratch is a time-consuming and expensive process, and therefore, not preferable. To address this problem, pre-trained LLMs are used for generic tasks. For example, LLMs are typically pre-trained on extensive and diverse datasets containing a wide variety of text from the internet. Pre-training involves exposing the model to a broad range of language patterns, allowing it to learn general linguistic features. However, for performing domain-specific tasks, adaptation of LLMs for the particular domain needs to be performed. In one example, LLMs may leverage transfer learning where the model is pre-trained on a large corpus of data and then fine-tuned for specific tasks or domains. This approach enables the model to transfer the knowledge gained during pre-training to various downstream applications.

It may be noted that a base model in an LLM refers to a pre-trained model that has been trained on a large corpus of data for a general natural language understanding and generation task. The pre-trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

In an example, the base model contains a large number of parameters and exhibits a high level of language understanding, making it a powerful starting point for a variety of natural language processing tasks. While the base model is pre-trained on a large corpus of general language data, fine-tuning or adapting the base model for specific tasks or domains enhances its performance and makes it more suitable for targeted applications.

Continuing further, an adapter refers to a smaller and task-specific module added to the base model to adapt the base model for a particular task or domain. The adapter includes a lightweight set of parameters that is trained on task-specific data while keeping all or majority of the base model's parameters frozen. In particular, the adapter is used to fine-tune the base model for a specific downstream task without extensively modifying its pre-trained parameters. This approach is beneficial when computational resources or labelled task-specific data are limited.

The server 208 may include suitable logic, circuitry, and interfaces, and/or code that is configured to store the template, the product story, and the source code. The server 208 may be configured to store the set of generative AI models 206. In an embodiment, the server 208 may be configured to store the first product documentation 214 associated with the product. The server 208 may be implemented as a cloud server and may execute operations through web applications, cloud applications, HTTP requests, repository operations, file transfer, and the like. Other example implementations of the server 208 may include, but are not limited to, a database server, a file server, a web server, a media server, an application server, a mainframe server, or a cloud computing server.

In an embodiment of the disclosure, the server 208 may be implemented as a plurality of distributed cloud-based resources by use of several technologies that are well known to those ordinarily skilled in the art. A person with ordinary skill in the art will understand that the scope of the disclosure may not be limited to the implementation of the server 208 and the system 202 as two separate entities. In certain embodiments, the functionalities of the server 208 can be incorporated in its entirety or at least partially in the system 202, without a departure from the scope of the disclosure.

Each of the first set of databases 210 may correspond to an organized collection of data that may be stored and accessed electronically from a computer system (such as the system 202). In an embodiment, the first set of databases 210 may be associated with the set of stakeholders and may store the set of preferences of the set of stakeholders associated with the product. Each database of the first set of databases 210 may be associated with the system 202 and may store the product story associated with the product. In an embodiment of the disclosure, each database of the first set of databases 210 may be configured to store the source code associated with the product. Each database of the first set of databases 210 may be designed to manage, store, retrieve, and update data efficiently. The structure of each of the first set of databases 210 base typically involves tables, records, and fields that can be managed through various database management systems (DBMS). Examples of each of the first set of databases 210 may include, but are not limited to, a relational database, a Non-Structured Query Language (SQL) database, a hierarchical database, a network database, a transactional database, a data warehouse, and a distributed database.

In operation, there may be a requirement to generate product documentation associated with the product. The product documentation may be needed for ensuring that users, developers, and stakeholders can effectively understand and utilize the product (such as a software product). The product documentation may serve as a comprehensive resource that guides users through installation, setup, and troubleshooting, enhancing their overall experience and productivity.

In an embodiment of the disclosure, the product corresponds to a software product that includes suitable logic or code to execute one or more operations. Examples of one or more operations include, but are not limited to, data storage operations, data backup operations, access control operations, or data processing operations. Examples of the product include, but are not limited to, an operating system, a cloud database, gaming software, a web application, a mobile application, or security software.

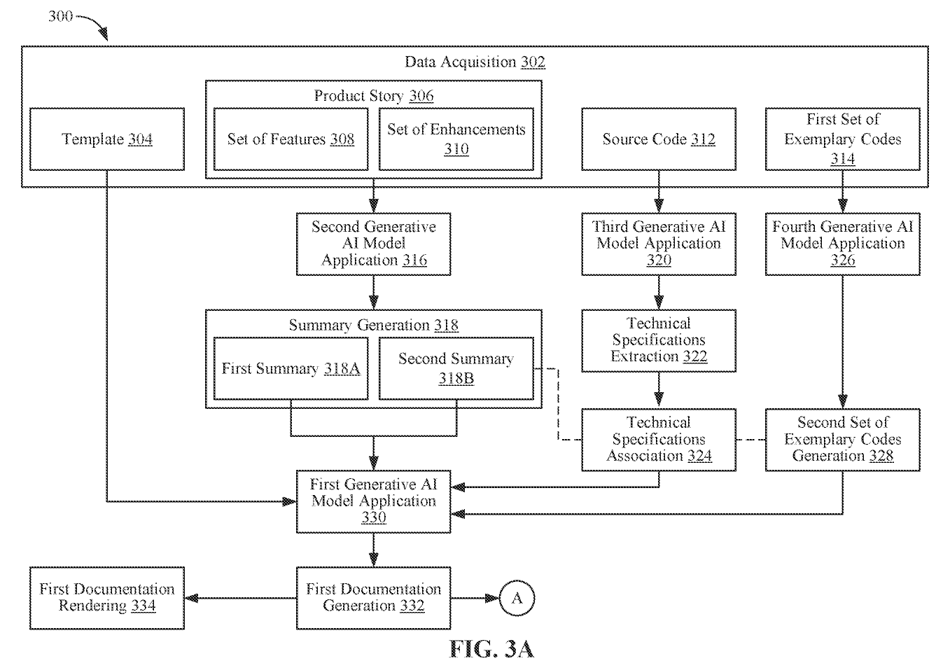

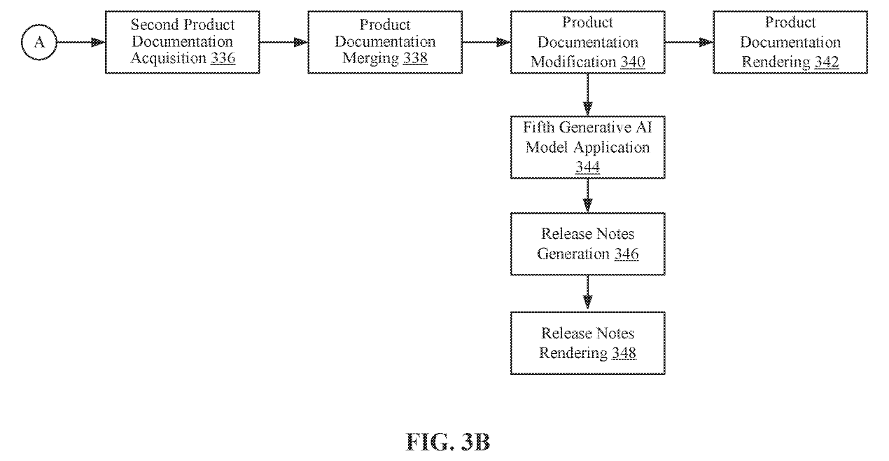

To generate the product documentation, the system 202 is configured to receive the template associated with the product. In an embodiment, the template includes the set of preferences of the set of stakeholders associated with the product. The set of stakeholders corresponds to one of the business users, the end users, the product developers, the sales representative, the system administrators, the marketing representatives, and the like. In an embodiment of the disclosure, the set of preferences of the set of stakeholders is associated with a number of words of the template, a number of the set of features associated with the product, a type of each of the set of features associated with the product, a number of the set of enhancements in the product, a number of words of a first summary associated the set of enhancements, a number of words of a second summary associated with the product, or any combination thereof. Details about the template are provided, for example, in FIG. 3.

In an embodiment of the disclosure, the system 202 is further configured to receive the product story associated with the product. The product story includes the set of enhancements in the product or the set of features of the product. In an embodiment of the disclosure, the set of features is associated with a management of the product, a performance of the product, access control of the product, scalability of the product, a user experience of the product, or any combination thereof. In an embodiment of the disclosure, the set of enhancements is associated with an enhancement associated with the management of the product, an enhancement associated with the performance of the product, an enhancement associated with the access control of the product, an enhancement associated with the scalability of the product, or an enhancement associated with the user experience of the end users, or any combination thereof. Details about the product story are provided, for example, in FIG. 3.

In an embodiment of the disclosure, the system 202 is further configured to receive the source code associated with the product. In an embodiment of the disclosure, the source code includes a set of instructions associated with the one or more operations of the product. In an embodiment of the disclosure, the source code corresponds to human-readable code that is written in a programming language (such as, but not limited to, Python, Java, JavaScript, or C++). The source code may be generated based on a syntax associated with the programming language or a grammar rule associated with the programming language. The source code includes, but is not limited to, functions, classes, methods, loops, and conditions based on the one or more operations associated with the product. The source code further includes configuration files that allow the first entity 212 to update operational parameters associated with the product. The operational parameters include, but are not limited to, memory parameters, buffer size parameters, or access control parameters.

The system 202 is further configured to apply at least one generative AI model of the set of generative AI model 206 to the template, the product story, and the source code. In an embodiment of the disclosure, the system 202 is configured to apply the set of generative AI models 206 to the template, the product story, and the source code. Specifically, the system 202 may be configured to apply the first generative AI model 206A to the template, the product story, and the source code. Details about the usage of the second generative AI model 206B, the third generative AI model 206C, the fourth generative AI model 206D, and the fifth generative AI model 206E are provided, for example, in FIG. 3.

The system 202 is further configured to generate the first product documentation 214 associated with the product. The system 202 is configured to generate the first product documentation 214 based on the set of preferences of the set of stakeholders and the application of the first generative AI model 206A to the template, the product story, and the source code. The utilization of the set of generative AI models 206 allows for increased efficiency and productivity for the generation of the first product documentation 214. Additionally, the utilization of the set of generative AI models 206 further reduces the time and effort required to generate and update the first product documentation 214. Such automation may ensure consistency and accuracy corresponding to each feature of the set of features within the first product documentation 214 and each enhancement of the set of enhancements within the first product documentation 214.

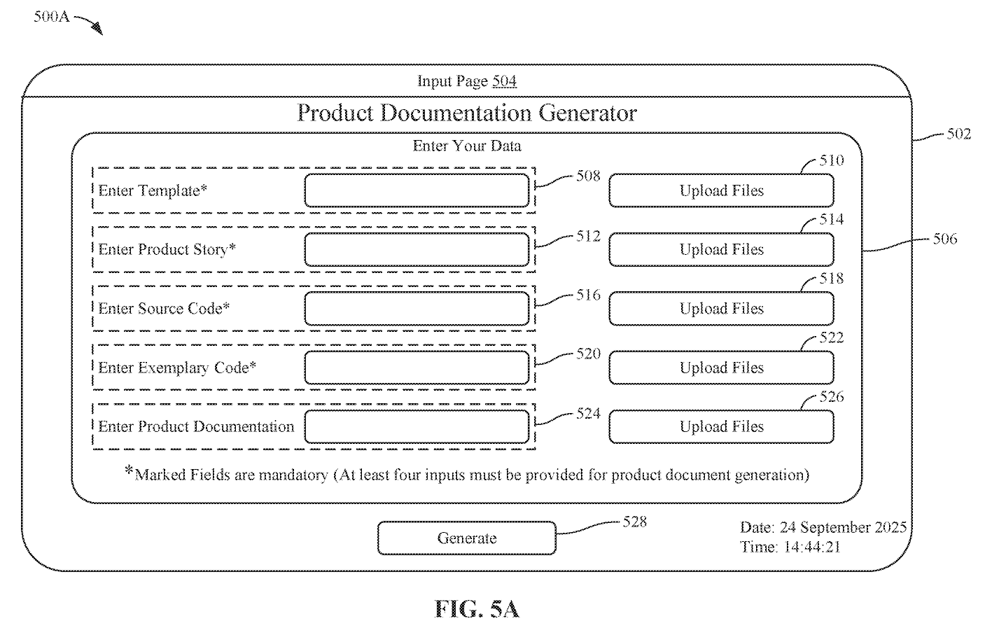

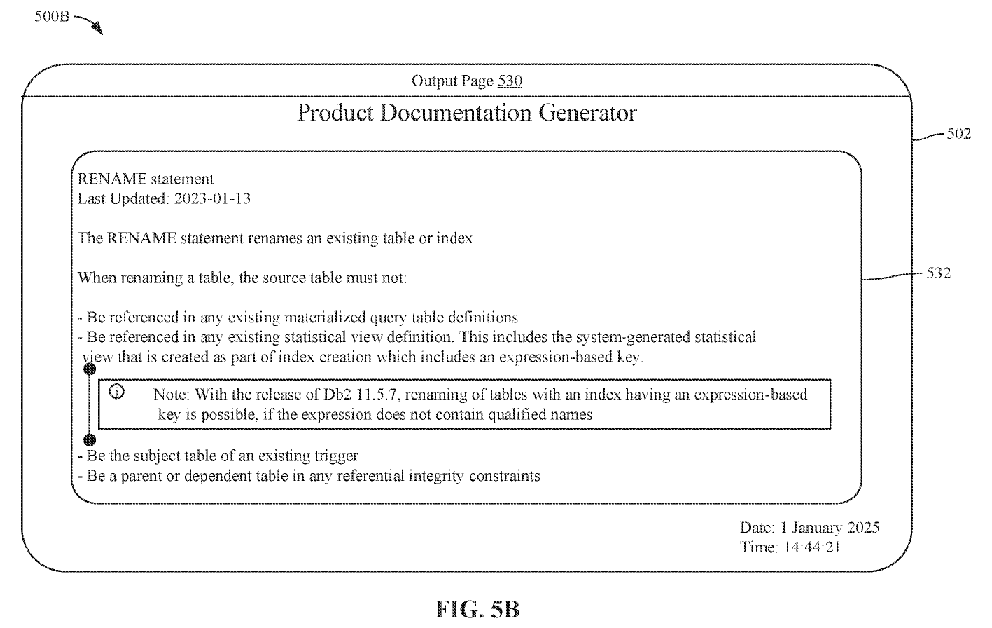

The system 202 is configured to render the generated first product documentation 214 (as shown in FIG. 5B). In an embodiment, the system 202 is configured to render the generated first product documentation 214 on the first user device 204 associated with the first entity 218. In various embodiments of the disclosure, the system 202 is configured to render an audio output indicative of the generation of the first product documentation 214. In various embodiments of the disclosure, the system 202 is configured to store the generated first product documentation 214 in the first set of databases 210. In various embodiments of the disclosure, the system 202 is configured to render the generated first product documentation 214 on a website associated with the product for usage by the set of stakeholders associated with the product.

FIG. 3A and FIG. 3B, collectively, is a diagram that illustrates exemplary operations for the generation of product documentation using artificial intelligence models, in accordance with an embodiment of the disclosure. FIG. 3A and FIG. 3B are explained in conjunction with elements from FIG. 1, and FIG. 2. With reference to FIG. 3A and FIG. 3B, there is shown a block diagram 300 that illustrates exemplary operations from 302 to 348, as described herein. The exemplary operations illustrated in the block diagram 300 may start at 302 and may be performed by any computing system, apparatus, or device, such as by the computer 102 of FIG. 1 or system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a data acquisition operation may be executed. In the data acquisition operation, the system 202 is configured to receive a template 304 associated with the product. In an embodiment of the disclosure, the template 304 includes the set of preferences of the set of stakeholders associated with the product. The set of stakeholders corresponds to one of the business users, the end users, the product developers, the sales representative, the system administrators, or the marketing representatives.

In an embodiment of the disclosure, the set of preferences may be associated with a format of the first product documentation and the priority of each individual section of a set of sections in the first product documentation. In an embodiment, the first product documentation may be different for each stakeholder of the set of stakeholders. By way of an example and example, the product documentation for sales representatives may differ significantly from that intended for end users in terms of content focus, depth, and purpose because sales representatives may require documentation that highlights the product's unique selling points, technical specifications, and competitive advantages, enabling them to effectively pitch the product and address customer concerns. This product documentation may include sales tools like scripts and objection-handling techniques, as well as insights into market trends and demographics. In contrast, the product documentation for end users may be primarily focused on usability, providing clear, step-by-step guides for installation, configuration, and troubleshooting. This may emphasize user experience through visuals like screenshots and offers practical support resources. Such differences in the product documentation may arise because sales representatives need to persuade and inform potential customers, while end users require practical assistance to navigate and utilize the software effectively. Therefore, the template including the ser of preferences may be used to tailor the product documentation to each audience to ensure that each stakeholder of the set of stakeholders has the specific information they need to succeed in their respective roles.

In an embodiment of the disclosure, the set of preferences of the set of stakeholders is associated with a number of words of the template 304, a number of a set of features 308 associated with the product, a type of each of the set of features 308 associated with the product, a number of the set of enhancements 310 in the product, a number of words of a first summary 318A associated the set of enhancements 318 in the product, a number of words of a second summary 318B associated with the set of features 308 in the product, or any combination thereof.

In an embodiment of the disclosure, at least one preference of the set of preferences is different for each stakeholder of the set of stakeholders. For example, a first preference of the set of preferences is indicative of a first number of words (such as 150 words, 200 words, 250 words, or 300 words) of the first summary 318A associated with the set of enhancements 318. The first preference is associated with the end users. Further, a second preference of the set of preferences is indicative of a second number of words (30 words, 60 words, 90 words, or 120 words) of the first summary 318A associated with the set of enhancements 310. The second preference is associated with the product developers. Additionally, there is a need to explain the set of enhancements 310 in the product to the end users in more detail than the product developers. To that end, the first number of words of the first summary 318A is greater than the second number of words of the first summary 318A based on the first preference and the second preference.

In an additional example, a third preference of the set of preferences is indicative of the first number of lines (such as 10 lines, 25 lines, 35 lines, or 50 lines) associated with the source code 312. The third preference is associated with the business owners. Further, a fourth preference of the set of preferences is indicative of a second number of lines (such as 100 lines, 150 lines, 175 lines, or 250 lines) associated with the source code 312. The fourth preference of the set of preferences is associated with the product developers. Additionally, there is a need to include a greater number of lines of the source code 312 for the product developers in the first product documentation 214 than for the business owners. To that end, the first number of lines associated with the source code 312 is greater than the second number of lines associated with the source code 312. based on the third preference and the fourth preference.

In an embodiment of the disclosure, the system 202 is configured to receive the template 304 from at least one of the set of stakeholders. Details about the acquisition of template 304 are provided, for example, in FIG. 5A. In various embodiments of the disclosure, the system 202 is configured to receive the template 304 from the first set of databases 210. By way of an example and not limitation, the template 304 for the business developers corresponds to: “[[Product name]], [[ The first number of the first summary associated with the set of enhancements 310]], or [[The first number of lines associated with the source code 312]]”. By way of an additional example and not limitation, the template 304 for the product developers corresponds to “[[Product name”, [[The second number of the second summary associated with the set of enhancements 310]], and [[The second number of lines associated with the source code 312]]”. In an embodiment of the disclosure, the system 202 is configured to input the template 304 to the first generative AI model 206A.

In various embodiments of the disclosure, the system 202 is further configured to receive a product story 306 associated with the product. The product story may be a narrative that outlines the journey of the product from conception to market, capturing its purpose, value, and impact on the end-users. The product story may encompass key elements that illustrate how the product addresses specific problems, enhancements made over time, and the features that set it apart from competitors. Specifically, the product story 306 includes the set of features 308 of the product or the set of enhancements 310 in the product. Each feature of the set of is specific attributes or functionalities of the product designed to fulfill particular needs or requirements, providing value to end-users, and distinguishing the product from the products of the competitors. Such a set of features may include core functionalities that enable the product to perform its main purpose, user interface elements that affect interaction, integration capabilities with other products, and performance characteristics related to speed and reliability. In contrast, the set of enhancements may refer to improvements or upgrades made to existing features or the overall product experience. The set of enhancements may aim to increase usability, performance, and user satisfaction based on feedback and changing market demands. The set of enhancements may involve usability improvements, performance upgrades, the addition of new features, and overall user experience improvements, such as visual updates or accessibility features. Specifically, the set of features may define what a product can do, while the set of enhancements may focus on evolving and improving those capabilities.

By way of example and not limitation, the set of features 308 may be associated with the management of the product, the performance of the product, the security of the product, the scalability of the product, and the like. The set of enhancements is associated with the enhancement associated with the management of the product, the enhancement associated with performance of the product, the enhancement associated with the security of the product, the enhancement associated with the scalability of the product, the enhancement associated with the user experience of the end users.

In an embodiment of the disclosure, the system 202 is configured to receive the product story 306 for the generation of the first product documentation 214. The first product documentation 214 is associated with the product. In various embodiments of the disclosure, the system 202 is configured to receive the product story 306 from the at least one stakeholder of the set of stakeholders. In various embodiments of the disclosure, the system 202 is configured to receive the product story 306 from the first set of databases 210 or the first user device 204.

In an embodiment of the disclosure, the system 202 is further configured to receive the source code 312 associated with the product. In an embodiment of the disclosure, the source code 312 includes a set of instructions associated with the one or more operations of the product. Examples of the one or more operations include, but are not limited to, the data storage operations, the backup operations, the access control operations, or the data processing operations. In an embodiment of the disclosure, the source code 312 corresponds to a human-readable code that is written in a programming language (such as Python, Java, JavaScript, C++). The source code 312 is generated based on a syntax associated with the programming language or a grammar rule associated with the programming language. The source code 312 includes, but is not limited to, the functions, the classes, the methods, the loops, and the conditions based on the one or more operations associated with the product. In an embodiment of the disclosure, the system 202 is configured to obtain the source code 312 from the first set of databases 210. In various embodiments of the disclosure, the system 202 is configured to receive the source code 312 from the at least one of the set of stakeholders. In an embodiment of the disclosure, the system 202 is configured to input the source code 312 to the third generative AI model 206C.

In an embodiment of the disclosure, the system 202 is configured to receive a first set of exemplary codes 314. In an embodiment of the disclosure, the first set of exemplary codes 314 is associated with a source code of a first set of products that may be similar to the product. In an embodiment of the disclosure, the system 202 is configured to obtain the exemplary code 314 from the first set of databases 210. In various embodiments of the disclosure, the system 202 is configured to receive the first set of exemplary codes 314 from the at least one of the set of stakeholders.

At 316, a second generative AI application operation may be executed. In the second generative AI application operation, the system 202 is configured to apply the second generative AI model 206B to the product story 306. In an embodiment of the disclosure, the system 202 is configured to apply the second generative AI model 206B on the product story 306 to generate each of the first summary 318A and the second summary 318B. The first summary 318A is associated with the set of enhancements 310 in the product. Further, the second summary 318B is associated with the set of features 308 of the product.

At 318, a summary generation operation may be executed. In the summary generation operation, the system 202 is configured to the first summary 318A and the second summary 318B based on the application of the second generative AI model 206B to the product story 306. In an embodiment of the disclosure, the first summary 318A is associated with the set of enhancements 310 in the product. Further, the second summary 318B is associated with the set of features 308 of the product. Specifically, the system 202 is configured to generate the second summary 318B based on the application of the second generative AI model 206B to the set of features 308.

By way of an example and not limitation, if the product corresponds to a cloud database and the set of features 308 may be associated with a performance of the cloud database (say query optimization), then second summary 318B corresponds to “Query Optimizer: A built-in query optimization engine that determines the most efficient way of executing queries. This reduces the time and computational resources required to return query results”. By way of an additional example and not limitation, the set of enhancements 310 associated with an enhancement in the performance of the cloud database, the first summary 318A corresponds to “Query Execution Optimization: Updates to the query optimizer, allowing it to more intelligently select execution plans based on workload and resource availability. For example, support for parallel query execution to leverage multi-core processors for faster performance”.

At 320, a third generative AI application operation may be executed. In the third generative AI application operation, the system 202 is configured to apply the third generative AI model 206C to the source code 312. In an embodiment of the disclosure, the system 202 is configured to apply the third generative AI model 206C to extract a set of technical specifications associated with the product. In an embodiment, the third generative AI model 206C may be trained to extract the set of technical specifications based on the analysis of the source code associated with the product. In an embodiment, the extracting of the set technical specifications from source code using the third generative AI model 206C may involve leveraging natural language processing (NLP) techniques to analyze and interpret the code's structure and functionality. In an embodiment, the third generative AI model 206C may be trained on diverse codebases. Based on the training, the third generative AI model 206C may learn to identify patterns, conventions, and documentation styles inherent in the code. Such training may enable the third generative AI model 206C to generate comprehensive specifications that describe the software’s architecture, APIs, and functionality in a human-readable format. In an embodiment, key features such as function signatures, variable types, and control flows may be systematically extracted, ensuring that the extracted set of technical specifications is both accurate and reflective of the underlying implementation. In an alternate embodiment of the disclosure, the third generative AI model 206C may implement attention mechanisms that may allow the third generative AI model 206C to focus on relevant code segments while ignoring irrelevant information. Details about the attention mechanisms are known in the art and therefore have been omitted for the sake of brevity.

At 322, a technical specifications extraction operation may be executed. In the technical specifications extraction operation, the system 202 is configured to extract the set of technical specifications based on the application of the third generative AI model 206C to the source code 312. The set of technical specifications is associated with the product. In an embodiment of the disclosure, each of the set of technical specifications is indicative of at least one portion (such as the classes, the functions, the methods, the loops, the conditions, or the variables) of the source code 312. The set of technical specifications is indicative of at least one of an architecture of the product, an execution flow of the source code 312, an interaction between Application Programming Interfaces (APIs) associated with the product, a time complexity (such as O(n), O(log n), or O(nlogn)) associated with the one or more operations of the product, consumption of the memory associated with the product, or encryption (such as Advanced Encryption Standard (AES)) standard that may be used by the product. In an embodiment of the disclosure, the architecture of the product corresponds to one of a microservice architecture or a monolithic architecture. In an embodiment of the disclosure, the execution flow of the source code 312 is indicative of a sequence for execution of the classes, the functions, the loops, or the conditions within the source code 312. In an embodiment of the disclosure, the consumption of the memory associated with the product is indicated by megabytes (MBs) (such as 10 MBs, 250 MBs, 700 MBs, or 1024 MBs)

At 324, a technical specifications association operation may be executed. In the technical specifications association operation, the system 202 is configured to associate the set of technical specifications with at least one of the set of enhancements 310 in the product or the set of features 308 of the product. In an embodiment of the disclosure, the system 202 is configured to associate the at least one portion of the source code 312 with the corresponding feature of the set of features 308 of the product. In various embodiments of the disclosure, the system 202 is configured to associate the at least one portion of the source code with the corresponding enhancement of the set of enhancements 310.

Referring back to 314, at 326, a fourth generative application operation may be executed. In the fourth generative application operation, the system 202 is configured to apply the fourth generative AI model 206D to the first set of exemplary codes 314. In an embodiment of the disclosure, the system 202 is configured to apply the fourth generative AI model 206D to generate a second set of exemplary codes. The fourth generative AI model 206D is trained to generate the second set of exemplary codes based on an application of a set of instructions to the first set of exemplary codes. The set of instructions is associated with one or more standards for the generation of the first product documentation 214. The set of standards is associated with at least a structure of each exemplary code of the first set of exemplary codes in the first product documentation 214. In an embodiment, the first set of exemplary codes may be associated with an operation/a functionality within the first set of products that may be associated with the product.

At 328, a second set of exemplary code generation operations may be executed. In the second set of exemplary codes generation operation, the system 202 is configured to generate the second set of exemplary codes based on the association and the application of the fourth generative AI model 206D to the first set of exemplary codes. In an embodiment of the disclosure, each exemplary code of the second set of exemplary codes be associated with the operation/the functionality within the product. Specifically, each exemplary code of the second set of exemplary codes may be product-specific codes that may be associated with and tuned in accordance with the product. In an embodiment of the disclosure, the system 202 is configured to input the second set of exemplary codes to the first generative AI model 206A.

At 330, a first generative AI application operation may be executed. In the first generative AI application operation, the system 202 is configured to apply the first generative AI model 206A to the template 304, the first summary 318A associated with the set of enhancements 310, the second summary 318B associated with the set of features 308, the association of the set of technical specifications with the at least one of the set of enhancements 310 in the product of the set of features 308 of the product, the second set of exemplary codes, or any combination thereof. In an embodiment of the disclosure, the system 202 is configured to apply the first generative AI model 206A to generate the first product documentation 214.

At 332, a first documentation generation operation may be executed. In the first documentation generation operation, the system 202 is configured to generate the first product documentation 214 based on the application of the first generative AI model 206A to the template 304, the first summary 318A associated with the set of enhancements 310, the second summary 318B associated with the set of features 308, the association of the set of technical specifications with the at least one of the set of enhancements 310 in the product of the set of features 308 of the product, the second set of exemplary codes, or any combination thereof. Additionally, the generated first product documentation 214 is different for each of the set of stakeholders.

In an embodiment, the Product documentation for the product (say the software product) may provide required information to help various stakeholders understand, implement, use, and support the product effectively. The product documentation typically includes user guides, technical manuals, application programming interface (API) references, frequently asked questions (FAQs), and troubleshooting guides. Specifically, the product documentation serves as a blueprint, ensuring smooth adoption, integration, and troubleshooting for different users, providing both high-level overviews and detailed instructions. The type and depth of documentation vary depending on the needs and expertise of the intended audience. As discussed above, the product documentation may be different for each stakeholder and may be tuned in accordance with the set of preferences of the corresponding stakeholder.

By way of example and not limitation, the product documentation for business users may focus on the capabilities, benefits, and use cases of the product. The product documentation for the business users may highlight how the product (say the software product) solves specific business problems, drives efficiency, and creates value. This type of product documentation typically includes executive summaries, case studies, and high-level overviews of features, emphasizing what the product does rather than the technical details because the business users are more interested in understanding the value proposition and Return on investment (ROI) the product brings to their organization.

For end users, the product documentation focuses on providing clear, step-by-step instructions for using the product. It includes user manuals, quick-start guides, FAQs, and visual aids such as screenshots or video tutorials. The goal is to simplify the experience for non-technical users by explaining how to perform specific tasks, navigate the interface, and troubleshoot common issues.

For product developers, the product documentation dives into the technical aspects of the product. It includes API references, software development kit (SDK) guides, code samples, and detailed instructions on integrating and extending the product. This may be because the developers require a deep understanding of how the product functions internally, including data structures, workflows, and third-party integrations. This type of documentation is highly technical and focuses on enabling developers to build upon the product or integrate it into larger systems seamlessly.

For sales representatives, the product documentation emphasizes the product’s relevance in the market and industry. It includes competitive analyses, feature comparisons, product benefits, and customer success stories. This is because sales representatives use this information to pitch the product to potential clients by demonstrating its unique selling points, scalability, and return on investment. The focus is on selling the product’s value and showing reasons why the product is a better choice for a customer than competing solutions.

For system administrators, the product documentation focuses on how to deploy, configure, and maintain the product. It includes installation guides, server configurations, backup procedures, and security protocols. System administrators need detailed, step-by-step technical documentation that explains system requirements, software dependencies, and troubleshooting techniques. This documentation ensures that the software runs smoothly in a secure and optimized environment, with a focus on system performance and maintenance.

For marketing representatives, product documentation highlights the product’s key features and benefits in a customer-centric way. It includes product brochures, feature highlights, and case studies. The product documentation for marketing representatives is designed to create awareness and generate interest by articulating the product’s benefits, competitive advantages, and success stories in relatable, non-technical language. The focus is on positioning the product to appeal to target audiences and align with industry trends.

Therefore, each stakeholder requires a tailored version of the documentation to meet their specific needs, with varying degrees of technical detail, emphasis, and focus. The system may generate the product documentation based on the needs of the corresponding stakeholders. Such needs may be included in the set of preferences associated with the corresponding stakeholder.

At 334, a first documentation rendering operation may be executed. In the first documentation rendering operation, the system 202 is configured to render the first product documentation 214. In an embodiment of the disclosure, the system 202 is configured to render the generated first product documentation 214 on the first user device 204 associated with the first entity 218. In various embodiments of the disclosure, the system 202 is configured to render the audio output indicative of the generated first product documentation 214. In various embodiments of the disclosure, the system 202 is configured to store the generated first product documentation 214 in the first set of databases 210. In various embodiments of the disclosure, the system 202 may utilize one or more prior versions of the first product documentation 214 to modify the first product documentation 214.

With reference to FIG. 3B, at 336, a second product documentation acquisition operation may be executed. In the second product documentation acquisition operation, the system 202 is configured to receive a second product documentation associated with the product. The second product documentation is associated with a prior version of the product. For example, if the current version of the product is 2.0, then the second product documentation may be associated with the product version of the product being 1.9.

At 338, a product documentation merging operation may be executed. In the product documentation merging operation, the system 202 is configured to merge the first product documentation 214 with the second product documentation. The merging of the documents may correspond to an addition of the new content from the first product documentation to the second product documentation.

At 340, a product documentation modification operation may be executed. In the product documentation modification operation, the system 202 is configured to modify the first product documentation 214 based on the merging of the first product documentation 214 with the second product documentation. In an embodiment of the disclosure, the system 202 is configured to modify the first product documentation 214 based on the addition of the new content. In an embodiment of the disclosure, the new content may be indicative of at least one enhancement of the set of enhancements 310 or at least one feature of the set of features 308.

At 342, a product documentation rendering operation may be executed. In the product documentation rendering operation, the system 202 is configured to render the modified first product documentation. In an embodiment of the disclosure, the system 202 is configured to render the modified first product documentation on the first user device 204 associated with the first entity 218. In various embodiments of the disclosure, the system 202 is configured to render an audio output indicative of the modified first product recommendation. In various embodiments of the disclosure, the system 202 is configured to store the modified first product documentation in the first set of databases 210.

At 344, a fifth generative AI application operation may be executed. In the fifth generative AI model application operation, the system 202 is configured to apply the fifth generative AI model 206E to the modified first product documentation. In an embodiment of the disclosure, the fifth generative AI model 206F is trained to generate a set of release notes associated with the product using the modified product documentation.

At 346, a release notes generation operation may be executed. In the release notes generation operation, the system 202 is configured to generate the set of release notes based on the application of the fifth generative AI model 206F to the modified first product documentation. The set of release notes is associated with the product. Each release note of the set of release notes is indicative of the at least one enhancement of the set of enhancements 310 or one or more new features of the product. Specifically, the Release notes may be official documents that accompany the release of a new version or update of the product. The release notes provide a concise overview of the changes, including new features, enhancements, bug fixes, known issues, and sometimes improvements in performance or security. Furthermore, the release notes help users, developers, and other stakeholders understand what has been updated or modified in the product and how those changes impact functionality. Also, the release notes serve as a quick reference guide for anyone looking to understand the latest improvements or changes in the product version.

At 348, a release notes rendering operation may be executed. In the release notes operation, the system 202 is configured to render the generated set of release notes. In an embodiment of the disclosure, the system 202 is configured to render the set of release notes on the first user device 204 associated with the first entity 218. In various embodiments of the disclosure, the system 202 is configured to render an audio output indicative of the set of release notes. In various embodiments of the disclosure, the system 202 is configured to store the set of release notes in the first set of databases 210.

It may be noted that throughout the description the product corresponds to the software product. However, the disclosure is not limited to the software products only, the product may correspond to other types of products such as, but not limited to, consumer electronics, medical devices, industrial equipment, automotive, pharmaceuticals, toys, or household products. Furthermore, in some embodiments of the disclosure, the functionalities of the second generative AI model 206B, the third generative AI model 206C, the fourth generative AI model 206D, the fifth generative AI model 206E, and the sixth generative AI model may be integrated with a single generative AI model (say the first generative AI model 206A). In such a scenario, the system 202 may utilize the first generative AI model 206A instead of the second generative AI model 206B, the third generative AI model 206C, the fourth generative AI model 206D, the fifth generative AI model 206E, and the sixth generative AI model.

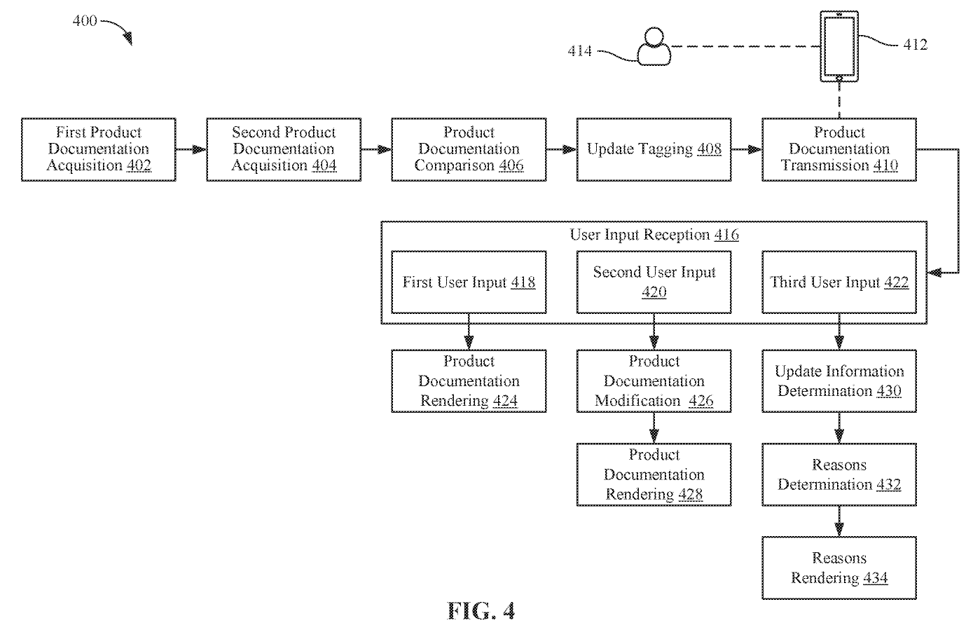

In various embodiments of the disclosure, the system 202 is configured to modify the first product documentation 214 based on one or more inputs from the first user device 204. Accordingly, a diagram is provided with reference to FIG. 4.

FIG. 4 is a diagram that illustrates exemplary operations for modification of product documentation, in accordance with an embodiment of the disclosure. FIG. 4 is explained in conjunction with elements from FIG. 1, FIG. 2, FIG. 3A, and FIG. 3B. With reference to FIG. 4, there is shown a block diagram 400 that illustrates exemplary operations from 402 to 434, as described herein. The exemplary operations illustrated in the block diagram 400 may start at 402 and may be performed by any computing system, apparatus, or device, such as by the computer 102 of FIG. 1 or system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, a first product documentation acquisition operation may be executed. In the first product documentation acquisition operation, the system 202 is configured to receive the first product documentation 214 associated with the product. In an embodiment of the disclosure, the system 202 is configured to receive the first product documentation 214 from the first set of databases 210. In various embodiments of the disclosure, the system 202 is configured to receive the first product documentation 214 from one or more sources (such as one or more websites associated with the product).

At 404, a second product documentation acquisition operation may be executed. In the second product documentation acquisition operation, the system 202 is configured to receive the second product documentation associated with the product. As discussed above, the second product documentation is associated with the prior version of the product. In an embodiment of the disclosure, the system 202 is configured to receive the second product documentation from the first set of databases 210. In various embodiments of the disclosure, the system 202 is configured to receive the second product documentation from one or more sources (such as the one or more websites) associated with the product.

At 406, a product documentation comparison operation may be executed. In the product documentation comparison operation, the system 202 is configured to compare the first product documentation 214 with the second product documentation. Details about the comparison of the first product documentation 214 and the second product documentation are provided, for example, in FIG. 3B. In an embodiment of the disclosure, the system 202 is configured to identify a set of updates in the first product documentation 214 based on the comparison of the first product documentation 214 with the second product documentation.

At 408, an update tagging operation may be executed. In the update tagging operation, the system 202 is configured to tag each update of the set of updates in the first product documentation 214 based on the comparison. In an embodiment of the disclosure, the system 202 is configured to tag each update of the set of updates based on the set of enhancements in the product. Details about the set of enhancements 310 are provided, for example, in FIG. 3A.

At 410, a product documentation transmission operation may be executed. In the product documentation transmission operation, the system 202 is configured to transmit the first product documentation 214 to a user device 412 (that may be an exemplary embodiment of the first user device 204 of FIG. 2). Further, each update of the set of updates is tagged in the first product documentation 214. The user device 412 is associated with a reviewer 414 who may be tasked to review or validate the changes in the product documentation in accordance with the set of preferences associated with each stakeholder of the set of stakeholders, in terms of the technicalities of the product, the set of features 308, and the set of enhancements 310.

At 416, a user input reception operation may be executed. In the user input reception operation, the system 202 is configured to receive one or more inputs from the user device 412. Further, the system 202 is configured to validate the first product documentation 214 based on the one or more inputs from the user device 412. In an embodiment of the disclosure, the system 202 is configured to receive a first input 418 from the user device 412. The first input 418 corresponds to an approval of the set of updates. The reception of the first input 418 allows for the validation of the set of updates in the first product documentation 214. In various embodiments of the disclosure, the system 202 is further configured to receive a second input 420 from the user device 412. The second input 420 corresponds to a disapproval of at least one update of the set of updates. In an embodiment, the second input 420 may also include at least one reason for the disapproval of at least one update of the set of updates. In various embodiments of the disclosure, the system 202 is configured to receive a third user input 422 from the user device 412. The third user input 422 includes a query associated with the at least one update of the set of updates. For example, the third user input 422 may correspond to one or more reasons behind the at least one update of the set of updates in the generated first product documentation.

At 424, a product documentation rendering operation may be executed. In an embodiment of the disclosure, the system 202 is configured to execute the product documentation operation based on the reception of the first user input 418. In the product documentation rendering operation, the system 202 is configured to render the generated first product documentation 214 based on the received first input 418. In an embodiment of the disclosure, the system 202 is configured to render the first product documentation 214 on the user device 412 based on the received first input 418. In various embodiments of the disclosure, the system 202 is configured to render an audio output based on the first input 418. The audio input is indicative of the first product documentation 214 based on the first input 418.

Referring back to 416, at 426, a product documentation modification operation may be executed. In an embodiment of the disclosure, the system 202 is configured to execute the product documentation modification operation based on the reception of the second user input 420. In the product documentation operation, the system 202 is configured to modify the first product documentation 214 based on the analysis of the at least one reason included in the received second input 420. Such analysis may correspond to the NLP analysis of the at least reason. In an embodiment of the disclosure, the system 202 is configured to the at least one update of the set of updates within the first product documentation 214.

At 428, a product documentation rendering operation may be executed. In the product documentation operation, the system 202 is configured to render the modified the first product documentation based on the NLP analysis of the at least one reason. Details about the rendering of the modified first product documentation are provided, for example, in FIG. 3B.

Referring back to 416, at 430, an update information determination operation may be executed. In an embodiment of the disclosure, the system 202 is configured to execute the update information determination operation based on the reception of the third user input 422. In the update information determination operation, the system 202 is configured to extract the update information based on the received third user input 422. The update information is associated with the at least one update in the first product documentation 214 and may be indicative of one or more reasons for the at least one update in the generated first product documentation.

In an embodiment, the update information may include an identifier associated with the at least one update of the set of updates, temporal data associated with the at least one update of the set of updates, a summary associated with the at least one update of the set of updates, or any combination thereof. In an embodiment of the disclosure, the system 202 may utilize the update information to validate the first product documentation 214 corresponding to the at least one update of the set of updates.

At 432, reasons determination operation may be executed. In the reasons determination operation, the system 202 is configured to determine one or more reasons for the at least one update based on the determined update information. In an embodiment, the one or more reasons may be determined based on an application of a sixth generative AI model on the determined update information.

At 434, reasons rendering operation may be executed. In the reasons rendering operation, the system 202 is configured to render the determined one or more reasons. In an embodiment of the disclosure, the system 202 is configured to render the one or more reasons on the user device 412. In various embodiments of the disclosure, the system 202 is configured to render an audio output indicative of the determined one or more reasons.

FIG. 5A is a diagram that illlustrates an exemplary first user interface for the generation of product documentation using artificial intelligence models, in accordance with an embodiment of the disclosure. FIG. 5A is explained in conjunction with elements from FIG. 1, FIG. 2, FIG. 3A, FIG. 3B, and FIG. 4. With reference to FIG. 5A, there is shown an exemplary diagram 500A that includes a user device 502 and an exemplary input page 504. The exemplary input page 504 includes a first user interface (UI) element 506, a second UI element 508, a third UI element 510, a fourth UI element 512, a fifth UI element 514, a sixth UI element 516, a seventh UI element 518, an eighth UI element 520, a ninth UI element 522, a tenth UI element 524, an eleventh UI element 526, and a twelfth UI element 528. The user device 502 is an example embodiment of the first user device 204 of FIG. 2.

With reference to FIG. 5A, the system 202 is configured to receive one or more inputs from the user device 502. The user device 502 includes a display unit (a user interface) that renders the input page 504 to the first stakeholder. The system 202 is configured to render the input page 504 on the user interface (UI) of the user device 502. The input page 504 corresponds to a web page or online form that is designed to collect information from the first entity 212 who wish to generate the first product documentation 214. In an embodiment of the disclosure, the input page 504 is used to gather relevant data from the first entity 212 to generate the first product documentation 214.

The first UI element 506 corresponds to a textbox that includes a message for the stakeholder, for example, “Enter Your Data”. The first UI element 506 further includes the second UI element 508, the third UI element 510, the fourth UI element 512, the fifth UI element 514, the sixth UI element 516, the seventh UI element 518, the eighth UI element 520, the ninth UI element 522, the tenth UI element 524, and the eleventh UI element 526. The second UI element 508 corresponds to a textbox labeled as “Enter Template”. The second UI element 508 is configured to receive the template 304. In an embodiment of the disclosure, the second UI element 508 is a mandatory input parameter that needs to be provided for the generation of the first product documentation 214.

The third UI element 510 corresponds to a button and is labeled as “Upload Files”. Upon selecting the third UI element 510, the system 202 may receive the template from the first stakeholder in the form of a file in any format such as a text file, an image file, or the like.

The fourth UI element 512 corresponds to a textbox and is labeled as “Enter Product Story”. The fourth UI element 512 is configured to receive the product story 306 associated with the product.”. In an embodiment of the disclosure, the fourth UI element 512 is a mandatory input parameter that needs to be provided for the generation of the first product documentation 214. The fifth UI element 514 corresponds to a button and is labeled as “Upload Files”. Upon selecting the fifth UI element 514, the system 202 may receive the product story in the form of a file in any format such as an image file, a text file, or the like.

The sixth UI element 516 corresponds to a textbox labeled as “Enter Source code”. In an embodiment of the disclosure, the system 202 is configured to receive the source code 312 associated with the product upon selecting the sixth UI element 516. In an embodiment of the disclosure, the sixth UI element 516 is a mandatory input parameter that needs to be provided for the generation of the first product documentation 214. The seventh UI element 518 corresponds to a button and is labeled as “Upload Files”. Upon selecting the seventh UI element 518, the system 202 may receive the source code in the form of a file in any format such as a source code file, a text file, an image file, or the like.

The eighth UI element 520 corresponds to a textbox labeled as “Enter Exemplary Code”. In an embodiment of the disclosure, the system 202 is configured to receive the first set of exemplary codes 314 associated with the product upon selecting the eighth UI element 520. In an embodiment of the disclosure, the eight UI element 520 is a mandatory input parameter that needs to be provided for the generation of the first product documentation 214. The ninth UI element 522 corresponds to a button and is labeled as “Upload Files”. Upon selecting the ninth UI element 522, the system 202 may receive the exemplary code in the form of a file in any format such as a text file, an image file, or the like.

The tenth UI element 524 corresponds to a textbox labeled as “Enter Product Documentation”. In an embodiment of the disclosure, the system 202 is configured to receive the second product documentation upon selecting the tenth UI element 524. The second product documentation is associated with the prior version of the product. The eleventh UI element 526 corresponds to a button and is labeled as “Upload Files”. Upon selecting the eleventh UI element 526, the system 202 may receive the second product documentation in the form of a file in any format such as a text file, an image file, or the like.

The twelfth UI element 528 corresponds to a button and is labeled as “Generate”. Upon selecting the twelfth UI element 528, the system 202 is configured to generate the first product documentation 214.

FIG. 5B is a diagram that illustrates an exemplary second user interface for the generation of product documentation using the artificial intelligence models, in accordance with an embodiment of the disclosure. FIG. 5B is explained in conjunction with elements from FIG. 1, FIG. 2, FIG. 3A, FIG. 3B, FIG. 4, and FIG. 5A. With reference to FIG. 5B, there is shown an exemplary diagram 500B that includes the user device 502 and an exemplary output page 530. The exemplary output page 530 includes a thirteenth UI element 532. The user device 502 is an example embodiment of the first user device 204 of FIG. 2.

With reference to FIG. 5B, the system 202 is configured to render the output page 530 on the display unit (or the user interface) of the user device 502. In an embodiment of the disclosure, the system 202 is configured to render the output page 530 based on the selection of the twelfth UI element 528. The output page 530 provides the information associated with the first product documentation 214.

The thirteenth UI element 532 corresponds to a textbox that the first product documentation 214. By way of an example and not limitation, the first product documentation 214 corresponds to

“RENAME statement

Last Updated 2023-01-13

The RENAME statement renames an existing tables or index.

When renaming a table, the source table must not:

Be referenced in any existing materialized query table definitions

Be referenced in any existing statistical view definitions. This includes the system-generated statistical view that is created as part of index creation which includes an expression-based key.

Note: With the release of Db2 11.5.7. renaming of tables with an index having an expression-based key is possible, if the expression does not contain qualified names.

Be the subject table of an existing trigger

Be a parent of dependent table in any referential integrity constraints”

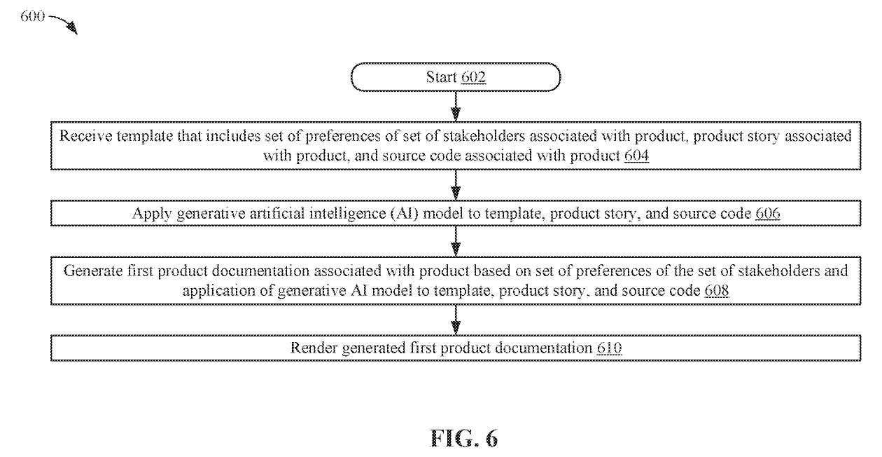

FIG. 6 is a flowchart that illustrates an exemplary method for the generation of product documentation using artificial intelligence models, in accordance with an embodiment of the disclosure. FIG. 6 is explained in conjunction with elements from FIG. 1, FIG. 2, FIG. 3A, FIG. 3B, FIG. 4, FIG. 5A, and FIG. 5B. With reference to FIG. 6, there is shown a flowchart 600. The operations of the exemplary method may be executed by any computing system, for example, by the computer 102 of FIG. 1. The operations of the flowchart 600 may start at 602.

At 604, the template 304 that includes the set of preferences of the set of stakeholders associated with the product, the product story 306 associated with the product, and the source code 312 associated with the product is received. The product story 306 includes at least one of the set of enhancements 310 in the product or the set of features 308 of the product. In an embodiment of the disclosure, the computer 102 may be configured to receive the template 304 which includes the set of preferences of the set of stakeholders associated with the product, the product story 306 associated with the product, and the source code 312 associated with the product. The product story 306 includes at least one of the set of enhancements 310 in the product or the set of features 308 of the product. Details about the template 304, the product story 306, and the source code 312 are provided, for example, in FIG. 3A.

At 606, the generative artificial intelligence (AI) model is applied to the template 304, the product story 306, and the source code 312. In an embodiment of the disclosure, the computer 102 may be configured to apply the generative AI model to the template, the product story, and the source code. In an embodiment of the disclosure, the system 202 is configured to apply the first generative AI model 206A, the second generative AI model 206B, the third generative AI model 206C, the fourth generative AI model 206D, the fifth generative AI model 206E, or any combination thereof. Details about the application of the set of generative AI models 206 are provided, for example, in FIG. 3A and FIG. 3B.

At 608, the first product documentation 214 associated with the product is generated based on the set of preferences of the set of stakeholders and the application of the generative AI model to the template 304, the product story 306, and the source code 312. In an embodiment of the disclosure, the computer 102 may be configured to generate the first product documentation 214 associated with the product based on the set of preferences of the set of stakeholders and the application of the generative AI model to the template 304, the product story 306, and the source code 312. Details about the generation of the first product documentation 214 are provided, for example, in FIG. 3A and FIG. 3B.

At 610, the generated first product documentation 214 is rendered. In an embodiment of the disclosure, the computer 102 may be configured to render the generated first product documentation. 214 Control may pass to the end. Details about the rendering of the first product documentation 214 are provided, for example, in FIG. 3A and FIG. 3B.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer,
a template comprising a set of preferences of a set of stakeholders associated with a product,
a product story associated with the product, wherein the product story comprises at least one of a set of enhancements in the product or a set of features of the product, and
a source code associated with the product;
applying, by the computer, a first generative artificial intelligence (AI) model to the template, the product story, and the source code;
generating, by the computer, a first product documentation associated with the product based on the set of preferences of the set of stakeholders and the application of the first generative AI model to the template, the product story, and the source code; and
rendering, by the computer, the generated first product documentation.

2. The computer-implemented method of claim 1, further comprising:
applying, by the computer, a second generative AI model to the product story;
generating, by the computer, each of a first summary and a second summary based on the application of the second generative AI model to the product story, wherein
the first summary is associated with the set of enhancements in the product, and
the second summary is associated with the set of features in the product;
applying, by the computer, the first generative AI model to the first summary and the second summary; and
generating, by the computer, the first product documentation based on the application of the first generative AI model to the first summary and the second summary.

3. The computer-implemented method of claim 1, further comprising:
applying, by the computer, a third generative AI model to the source code;
extracting, by the computer, a set of technical specifications associated with the product based on the application of the third generative AI model to the source code;
associating, by the computer, the set of technical specifications with the at least one of the set of enhancements in the product or the set of features of the product;
applying, by the computer, the first generative AI model to the association of the set of technical specifications with the at least one of the set of enhancements in the product or the set of features of the product; and
generating, by the computer, the first product documentation based on the application of the first generative AI model to the association of the set of technical specifications with the at least one of the set of enhancements in the product or the set of features of the product.

4. The computer-implemented method of claim 3, further comprising:
receiving, by the computer, a first set of exemplary codes;
applying, by the computer, a fourth generative AI model to the first set of exemplary codes;
generating, by the computer, a second set of exemplary codes based on the association and the application of the fourth generative AI model to the first set of exemplary codes; and
applying, by the computer, the first generative AI model to the second set of exemplary codes; and
generating, by the computer, the first product documentation based on the application of the first generative AI model to the second set of exemplary codes.

5. The computer-implemented method of claim 1, further comprising:
receiving, by the computer, a second product documentation associated with the product, wherein the second product documentation is associated with a prior version of the product;
merging, by the computer, the first product documentation with the second product documentation;
modifying, by the computer, the first product documentation based on the merging of the first product documentation with the second product documentation; and
rendering, by the computer, the modified first product documentation.

6. The computer-implemented method of claim 5, further comprising:
applying, by the computer, a fifth generative AI model to the modified first product documentation;
generating, by the computer, a set of release notes associated with the product based on the application of the fifth generative AI model to the modified first product documentation; and
rendering, by the computer, the generated set of release notes.

7. The computer-implemented method of claim 5, further comprising:
comparing, by the computer, the first product documentation with the second product documentation;
tagging, by the computer, each update of a set of updates in the first product documentation based on the comparison; and
transmitting, by the computer, the first product documentation to a user device based on the tagging of each update of the set of updates in the first product documentation.

8. The computer-implemented method of claim 7, further comprising:
receiving, by the computer, a first input from the user device, wherein the first input corresponds to an approval of the set of updates; and
rendering, by the computer, the generated first product documentation based on the received first input.

9. The computer-implemented method of claim 8, further comprising:
receiving, by the computer, a second input from the user device, wherein the second input corresponds to a disapproval of at least one update of the set of updates; and
modifying, by the computer, the generated first product documentation based on the received second input; and
rendering, by the computer, the modified first product documentation.

10. The computer-implemented method of claim 8, further comprising:
receiving, by the computer, a third input from the user device, wherein the third input comprises a query associated with at least one update of the set of updates;
determining, by the computer, update information associated with the at least one update in the first product documentation based on the received third input;
determining, by the computer, one or more reasons for the at least one update based on the determined update information; and
rendering, by the computer, the determined one or more reasons.

11. The computer-implemented method of claim 1, wherein the set of stakeholders corresponds to one of business users, end users, product developers, sales representatives, system administrators, or marketing representatives.

12. A system, comprising:
a processor set;
one or more computer-readable storage media; and
program instructions stored on the one or more computer-readable storage media, the program instructions executable by the processor set to cause the processor set to:
receive a template that comprises a set of preferences of a set of stakeholders associated with a product, a product story associated with the product, and a source code associated with the product, wherein the product story comprises at least one of a set of enhancements in the product or a set of features of the product;
apply a generative artificial intelligence (AI) model to the template, the product story, and the source code;
generate a first product documentation associated with the product based on the set of preferences of the set of stakeholders and the application of the generative AI model to the template, the product story, and the source code; and
render the generated first product documentation.

13. The system of claim 12, wherein the program instructions further cause the processor set to:
apply the generative AI model to the product story;
generate each of a first summary and a second summary based on the application of the generative AI model to the product story, wherein the first summary is associated with the set of enhancements in the product, and wherein the second summary is associated with the set of features in the product;
apply the generative AI model to the first summary and the second summary; and
generate the first product documentation based on the application of the generative AI model to the first summary and the second summary.

14. The system of claim 12, wherein the program instructions further cause the processor set to:
apply the generative AI model to the source code;
extract a set of technical specifications associated with the product based on the application of the generative AI model to the source code;
associate the set of technical specifications with the at least one of the set of enhancements in the product or the set of features of the product;
apply the generative AI model to the association of the set of technical specifications with the at least one of the set of enhancements in the product or the set of features of the product; and
generate the first product documentation based on the application of the generative AI model to the association of the set of technical specifications with the at least one of the set of enhancements in the product or the set of features of the product.

15. The system of claim 14, wherein the program instructions further cause the processor set to:
receive a first set of exemplary codes;
apply the generative AI model to the first set of exemplary codes;
generate a second set of exemplary codes based on the association and the application of the generative AI model to the first set of exemplary codes; and
apply the generative AI model to the second set of exemplary codes; and
generate the first product documentation based on the application of the generative AI model to the second set of exemplary codes.

16. The system of claim 12, wherein the program instructions further cause the processor set to:
receive a second product documentation associated with the product, wherein the second product documentation is associated with a prior version of the product;
merge the first product documentation with the second product documentation;
modify the first product documentation based on the merge of the first product documentation with the second product documentation; and
render the modified first product documentation.

17. The system of claim 16, wherein the program instructions further cause the processor set to:
apply the generative AI model to the modified first product documentation;
generate a set of release notes associated with the product based on the application of the generative AI model to the modified first product documentation; and
render the generated set of release notes.

18. The system of claim 17, wherein the program instructions further cause the processor set to:
compare the first product documentation with the second product documentation;
tag each update of a set of updates in the first product documentation based on the comparison; and
transmit the first product documentation to a user device, wherein each update of the set of updates is tagged in the first product documentation.

19. The system of claim 12, wherein the set of stakeholders corresponds to one of business users, end users, product developers, sales representatives, system administrators, or marketing representatives.

20. A computer program product for generation of a product documentation using a generative artificial intelligence (AI) model, the computer program product comprising:
one or more computer-readable storage media; and program instructions stored on the one or more computer-readable storage media to perform operations comprising:
receiving a template that comprises a set of preferences of a set of stakeholders associated with a product, a product story associated with the product, and a source code associated with the product, wherein the product story comprises at least one of a set of enhancements in the product or a set of features of the product;
applying the generative AI model to the template, the product story, and the source code;
generating the product documentation associated with the product based on the set of preferences of the set of stakeholders and the application of the generative AI model to the template, the product story, and the source code; and
rendering the generated product documentation.
